(19) United States
(12) Patent Application Publication
(10) Pub. No.: US 2005/0143531 A1
(43) Pub. Date: Jun. 30, 2005

(54) Urethane-modified polyester resin composition

(76) Inventors: Ju-Kil Lee, Sungnam-city (KR); Deok-Min Park, Anyang-city (KR)

Correspondence Address: CANTOR COLBURN LLP, 55 Griffin Road South, Bloomfield, CT, 06002, US

(21) Appl. No.: 10/748,971

(22) Filed: Dec. 30, 2003

(51) Int. Cl. C08G 69/48; C08F 283/04

(52) U.S. Cl. 525/424

(57) ABSTRACT

A urethane-modified polyester resin composition used for undercoating a PCM steel sheet for home appliances or construction materials is produced by an addition reaction of a polyester resin having a hydroxyl value of about 10 to 50 mgKOH/g and a weight average molecular weight of about 5,000 to 20,000 and isocyanate. The isocyanate is reacted with the polyester resin in a proportion of 20 to 80% with respect to an equivalent weight of the polyester resin. A paint including the urethane-modified polyester resin composition has improved adhesion between the undercoat film and a substrate or topcoat film and has enhanced processibility.

### BACKGROUND OF THE INVENTION

1. Field of the Invention

This invention relates to a urethane-modified polyester resin composition for undercoating a pre-coated metal (PCM) steel sheet in home appliances or construction materials. More particularly, the invention relates to a urethane-modified polyester resin composition having enhanced processibility after undercoating or topcoating, and improved adhesiveness between the undercoat film and a substrate as well as adhesiveness between the undercoat film and the topcoat film.

2. Description of the Related Art

Generally, resins of paints for coating a PCM steel sheet are of various kinds such as acryl based, urethane based, epoxy based, polyester based, silicon based, fluorine based or polyvinylchloride based resins. Most of the paints are thermosetting. The polyester based and epoxy based resins are widely used in the paints except when specific properties are required for the paints. Above all, the polyester based resin is the most frequently used in the paints.

The paints for undercoating the PCM steel sheet require excellent physical properties such as processibility that represents flexibility of a film after coating, pencil hardness, adhesion between an undercoat film and a substrate or topcoat film, a solvent resistance, etc. They also require chemical properties such as acid resistance, alkali resistance or weather resistance. Additionally, the paints require operating properties that determine product yields and costs.

A paint including the polyester based resin (hereinafter, referred to as a polyester based paint) and a paint including the epoxy based resin (hereinafter, referred to as an epoxy based paint) have been used as two major paints for undercoating PCM steel sheet. Polyester based paint has excellent processibility after topcoating, chemical resistance and operating property, but has poor scratch resistance and adhesion between the undercoat film and the substrate or topcoat film. Epoxy based paint is excellent in scratch and adhesion between the undercoat film and the substrate or topcoat film, but is poor at processibility.

Since properties of the polyester based paint and the epoxy based paint are different from each other, the paints for undercoating the PCM steel sheet have been divided into two classes such as a paint for home appliances and a paint for construction materials. Thus, a single or unified paint for undercoating PCM steel sheet that has the combined advantages of the polyester based paint and the epoxy based paint would have significant advantages.

### SUMMARY OF THE INVENTION

It is a feature of the invention to provide a urethane-modified polyester resin composition suitable for a unified paint composition that is applicable both to home appliances and construction materials with improved adhesion between an undercoat film and a substrate or topcoat film and enhanced processibility.

In accordance with one aspect of the invention, the urethane-modified polyester resin composition is produced by an addition reaction of a polyester resin having a hydroxyl value of about 10 to 50 mgKOH/g and a weight average molecular weight of about 5,000 to 20,000 and isocyanate. The isocyanate is reacted with the polyester resin in a proportion of 20 to 80% with respect to an equivalent weight of the polyester resin in urethane-modified polyester resin composition.

The paint for undercoating the PCM steel sheet including the urethane-modified polyester resin composition has improved adhesion between the undercoat film and the substrate or topcoat film in comparison with the polyester based paint and improved processibility.

### DETAILED DESCRIPTION OF THE INVENTION

The invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

A urethane-modified polyester resin composition used for a paint undercoating a PCM steel sheet has improved processibilty and enhanced adhesion between the undercoat film and a substrate or topcoat film. In order to improve poor adhesion between the undercoat film and the substrate or topcoat film that appears in the polyester based paint, and poor processibility that appears in the epoxy based paint, the urethane-modified polyester resin composition is produced by an addition reaction of a polyester resin having a hydroxyl value of about 10 to 50 mgKOH/g and a weight average molecular weight of about 5,000 to 20,000 and isocyanate (isocyanate monomers). The isocyanate is reacted with the polyester resin in a proportion of 20 to 80% with respect to an equivalent weight of the polyester resin. The paint including the urethane-modified polyester resin composition used for undercoating the PCM steel sheet has improved processibility as well as improved adhesion between the undercoat film and the substrate or topcoat film.

Examples of a glycol component of the polyester resin include ethylene glycol, propylene glycol, 1,4-butylene glycol, 1,6-hexanediol, neopentyl glycol, methyl propanediol, cyclohexane dimethanol, hydrogenated bisphenol A, ethylene oxide added bisphenol A, propylene oxide added bisphenol A, ethylene oxide added bisphenol F, propylene oxide added bisphenol F, ethylene oxide added bisphenol S, propylene oxide added bisphenol S, etc. These can be used alone or in a mixture thereof.

Preferably, the glycol component of the polyester resin includes about 20 to 100% of a first glycol and about 0 to 80% of a second glycol based on a total equivalent weight of the glycol. The first glycol may include etylene glycol, neopentyl glycol, methyl propanediol, etc. and the second glycol may include propylene glycol, 1,4-butylene glycol, 1,6-hexanediol, cyclohexane dimethanol, hydrogenated bisphenol A, etc.

Examples of an acid component of the polyester resin include phthalic anhydrides, tetrahydrophthalic anhydrides, isophthalic acid, terephthalic acid, adipic acid, azelaic acid, sebacic acid, cyclohexane diacid, trimellitic anhydrides, etc. These can be used alone or in a mixture thereof.

Preferably, the acid component of the polyester resin includes about 50 to 100% of an aromatic acid and about 0 to 50% of an aliphatic acid based on a total equivalent weight of the acid. Examples of the aromatic acid include phthalic anhydrides, tetrahydrophthalic anhydrides, isophthalic acid, terephthalic acid, etc. and examples of the aliphatic acid include adipic acid, azelaic acid, sebacic acid, cyclohexane diacid, etc. These can be used alone or in a mixture thereof.

When the hydroxyl value of the polyester resin is less than about 10 mgKOH/g, the curing property of the polyester resin deteriorates, which is unpreferable. When the hydroxyl value of the polyester resin is more than about 50 mgKOH/g, processability of a cured film is damaged, which is unpreferable.

When the weight average molecular weight of the polyester rein is less than about 5000, processability of the cured film deteriorates, which is unpreferable. When the weight average molecular weight of the polyester rein is more than about 20,000, the viscosity of the resin increases, thereby damaging operation properties, which is unpreferable.

Accordingly, the hydroxyl value of the polyester resin is preferably about 10 to 50 mgKOH/g, and the weight average molecular weight of the polyester resin is preferably about 5,000 to 20,000.

Examples of the isocyanate include 2,4-toluene diisocyanate, 2,6-toluene diisocyanate, 4,4′-diphenyl methane diisocyanate, 2,4′-diphenyl methane diisocyanate, tetramethylxylene diisocyanate, hexamethylene diisocyanate, isophorone diisocyanate, polymethylene polyphenylene polyisocyanate, etc. These may be used alone or in a mixture thereof.

When a urethane modification ratio is less than about 20%, the effect of modification by urethane is not apparent. When the urethane modification ratio exceeds about 80%, the quantity of the hydroxyl group remaining in the polyester resin after the modification is small, thereby damaging the curing property during a curing reaction and the solvent (methyl ethyl ketone) resistance. The modification ratio of the isocyanate to the polyester resin (the equivalent ratio to an alcohol residue) is about 20 to 80% based on an equivalent weight of the polyester resin.

The polyester resin has the hydroxyl value of about 10 to 50 mgKOH/g and the weight average molecular weight of about 5,000 to 20,000. These values may be changed by using the glycol and the acid. The isocyanate is reacted with the polyester resin in a proportion of about 20 to 80% with respect to an equivalent weight of the polyester resin.

Hereinafter, the invention will be described in detail by the following examples.

Preparation of Thermosetting Polyester Resins

### SYNTHETIC EXAMPLE 1

A thermometer, a condenser, a stirrer, a water removing condenser and a heating device were connected to a 5-L four-neck flask. 272 g of neopentyl glycol, 358 g of cyclohexane dimethanol (90%), 308 g of 1,6-hexanediol, 774 g of isophthalic acid and 339 g of terephthalic acid were added to the flask and then mixed. The reactants were heated to 240° C. with mild stirring. A thermosetting polyester resin 1825 g was obtained by a polymerization reaction. The obtained polyester resin has a hydroxyl value of 29 mgKOH/g and a weight average molecular weight of 15,000.

### SYNTHETIC EXAMPLE 2

A thermometer, a condenser, a stirrer, a water removing condenser and a heating device were connected to a 5-L four-neck flask. 582 g of neopentyl glycol, 279 g of 1,6-hexanediol, 499 g of isophthalic acid, 499 g of terephthalic acid and 219g of adipic acid were added to the flask and then mixed. The reactants were heated to 240° C. with mild stirring. A thermosetting polyester resin 2074 g was obtained by a polymerization reaction. The obtained polyester resin has a hydroxyl value of 25 mgKOH/g and a weight average molecular weight of 20,000.

### SYNTHETIC EXAMPLE 3

A thermometer, a condenser, a stirrer, a water removing condenser and a heating device were connected to a 5-L four-neck flask. 308 g of neopentyl glycol, 240 g of cyclohexane dimethanol (90%), 354 g of 1,6-hexanediol, 775 g of isophthalic acid and 399 g of terephthalic acid were added to the flask and then mixed. The reactants were heated to 240° C. with mild stirring. A thermosetting polyester resin 1825 g was obtained by a polymerization reaction. The obtained polyester resin has a hydroxyl value of 29 mgKOH/g and a weight average molecular weight of 18,000.

### SYNTHETIC EXAMPLE 4

A thermometer, a condenser, a stirrer, a water removing condenser and a heating device were connected to a 5-L four-neck flask. 502 g of neopentyl glycol, 387 g of 1,6-hexanediol, 849 g of isophthalic acid and 438 g of terephthalic acid were added to the flask and then mixed. The reactants were heated to 240° C. with mild stirring. A thermosetting polyester resin 1900 g was obtained by a polymerization reaction. The obtained polyester resin has a hydroxyl value of 24 mgKOH/g and a weight average molecular weight of 19,000.

Preparation of Urethane-Modified Polvester Resin Compositions

### EXAMPLE 1

A thermometer, a condenser, a stirrer and a heating device were connected to a 2-L four-neck flask. 500 g of the polyester resin obtained in Synthetic Example 1 was added to the flask. 750 g of an aromatic solvent that is commercially available by SK Corporation, Korea under the trade name of KOCOSOL-150 was added to the flask for dissolving and diluting the polyester resin. Then, 12 g of tetramethylxylene diisocyanate was added to the flask. The reaction was carried out at 70° C. to give a urethane-modified polyester resin composition.

### EXAMPLE 2

A thermometer, a condenser, a stirrer and a heating device were connected to a 2-L four-neck flask. 500 g of the polyester resin obtained in Synthetic Example 2 was added to the flask. 750 g of an aromatic solvent that is commercially available by SK Corporation, Korea under the trade name of KOCOSOL-150 was added to the flask for dissolving and diluting the polyester resin. Then, 13 g of tetramethylxylene diisocyanate was added to the flask. The reaction was carried out at 70° C. to give a urethane-modified polyester resin composition.

### EXAMPLE 3

A thermometer, a condenser, a stirrer and a heating device were connected to a 2-L four-neck flask. 500 g of the polyester resin obtained in Synthetic Example 3 was added to the flask. 750 g of an aromatic solvent that is commercially available by SK Corporation under the name of KOCOSOL-150 was added to the flask for dissolving and diluting the polyester resin. Then, 13 g of tetramethylxylene diisocyanate was added to the flask. The reaction was carried out at 70° C. to give a urethane-modified polyester resin composition.

### EXAMPLE 4

A thermometer, a condenser, a stirrer and a heating device were connected to a 2-L four-neck flask. 500 g of the polyester resin obtained in the synthetic example 4 was added to the flask. 750 g of an aromatic solvent that is commercially available by SK Corporation, Korea under the trade name of KOCOSOL-150 was added to the flask for dissolving and diluting the polyester resin. Then, 13 g of tetramethylxylene diisocyanate was added to the flask. The reaction was carried out at 70° C. to give a urethane-modified polyester resin composition.

Preparation of Paints

In order to determine post-applying properties of paints, each including the urethane-modified polyester resin compositions obtained in Example 1 to 4, the resin compositions obtained in Examples 1 to 4 and melamine curing agents were mixed to give undercoating paints used for home appliances. Each of the paints has a formulation shown in Table 1.

TABLE 1

| Ingredients | Contents (wt %) |
|---|---|
| urethane-modified polyester | 60 |
| resin composition obtained in | |
| Examples 1 to 4 | |
| titanium dioxide (TiO₂) | 10 |
| strontium chromate | 10 |
| dispersing agent | 0.2 |
| melamine curing agent | 3.0 |
| acid catalyst | 0.3 |
| antifoaming agent | 0.5 |
| solvent | 16 |
| Total | 100 |

The dispersing agent is commercially available from EFKA Additives B.V. under the trade name of EFKA-4050. The melamine curing agent is commercially available from CYTEC Industries Inc. under the trade name of Cymel-303. The acid catalyst is commercially available from KING Industries under the trade name of Nacure-5225. The antifoaming agent is commercially available from EFKA Additives B.V. under the trade name of EFKA-2021. The solvent is a mixture of cyclohexanone, xylene and butylsellosolve (40:30:30 of weight ratio).

### COMPARATIVE EXAMPLE 1

For comparison, a polyester based paint for undercoating the PCM steel sheet was formulated. The paint has a formulation shown in Table 2.

TABLE 2

| Ingredients | Contents (wt %) |
|---|---|
| polyester resin | 35 |
| titanium dioxide (TiO₂) | 10 |
| strontium chromate | 10 |
| dispersing agent | 0.2 |
| melamine curing agent | 2.0 |
| acid catalyst | 0.3 |
| antifoaming agent | 0.5 |
| solvent | 42 |
| Total | 100 |

In Table 2, the polyester resin is commercially available from DPI Co., Ltd., Korea under the name of NORUESTER-1000. The other ingredients are identical to the ingredients described above.

### COMPARATIVE EXAMPLE 2

An epoxy based paint for undercoating the PCM steel sheet was formulated. The paint has a formulation shown in Table 3.

TABLE 3

| Ingredients | Contents (wt %) |
|---|---|
| epoxy resin | 25 |
| titanium dioxide (TiO₂) | 8 |
| strontium chromate | 12 |
| dispersing agent | 0.1 |
| melamine curing agent | 2.0 |
| acid catalyst | 0.1 |
| antifoaming agent | 0.3 |
| solvent | 52.5 |
| Total | 100 |

In Table 3, the epoxy resin is commercially available from DPI, Co., Ltd., Korea under the trade name of NORUPOXY-2210. The other ingredients are identical to the ingredients described above.

Film Properties

Experiments

Paints having the resin compositions obtained in Examples 1 to 4 and paints obtained in Comparative Examples 1 and 2 were respectively applied to steel sheets for undercoating. Each steel sheet as a substrate had been treated with a zinc phosphoric acid.

Each paint was applied to the substrate to form a film having a thickness of 5±2μm. The surface temperature of the substrate was 224° C.

A topcoating paint for home appliances including 0.5 to 1% of hydroxyl group and a thermosetting resin having a molecular weight of 13,000 and Tg of 12° C. was applied to the substrate.

Film properties were tested and the results are shown in Table 4.

TABLE 4

| | | | | | Polyester | |
|---|---|---|---|---|---|---|
| | | | | | resin | Epoxy resin |
| Resin in | | | | | (Comparative | (Comparative |
| the paint | Example 1 | Example 2 | Example 3 | Example 4 | Example 1) | Example 2) |
| gloss | 91 | 91 | 92 | 91 | 91 | 87 |
| (60_{°}) | | | | | | |
| solvent | 100≧ | 100≧ | 100≧ | 100≧ | 100≧ | 100≧ |
| resistance | | | | | | |
| processibility | 1T | 1T | 1T | 2T | 2T | 4T |
| pencil | H | H | H | H | H | H |
| hardness | | | | | | |
| adhesion | 100/100 | 100/100 | 100/100 | 100/100 | 100/100 | 100/100 |
| acid | good | good | good | good | good | Good |
| resistance | | | | | | |
| alkali | good | good | good | good | good | Good |
| resistance | | | | | | |
| boiling | good | good | good | good | good | Good |
| water | | | | | | |
| resistance | | | | | | |
| adhesion | ⊚ | ⊚ | ⊚ | ⊚ | Δ | ⊚ |
| between | | | | | | |
| undercoat | | | | | | |
| film and | | | | | | |
| substrate | | | | | | |
| or topcoat | | | | | | |
| film | | | | | | |

In adhesion between the undercoat film and the substrate or topcoat film, ‘⊚’ represents excellent, ‘Δ’ represents ordinary and ‘X’ represents poor.

The gloss was determined by American Society for Testing and Materials D-523 (ASTM D-523), and the solvent resistance was determined by National Coil Coaters Association II-18 (NCCA II-18) using methyl ethyl ketone as a solvent. The processibility was determined by NCCA-II-19, and pencil hardness was determined by NCCA-II-12. The adhesion was determined by NCCA-II-20, and the acid resistance and alkali resistance were determined by ASTM-D-1308.

To determine the boiling water resistance, the substrate was dipped into boiling water for 24 hours and then film condition was observed with naked eyes.

To determine the adhesion between the undercoat film and the substrate or topcoat film, the film was scratched with a constant strength using a coin. The quantity of the detached film was observed with naked eyes.

As can be seen from Table 4, the paint including the resin of comparative example 1 has poor adhesion between the undercoa film and the substrate or topcoat film. The paint including the resin of comparative example 2 has good adhesion between the undercoat film and the substrate or topcoat film but poor gloss. The paints including the urethane-modified polyester resin compositions of Examples 1 to 4 have good adhesion between the undercoat film and the substrate or topcoat film and excellent gloss.

As described above, the urethane-modified polyester resin composition for the paint undercoating the PCM steel sheet, adhesion between the undercoat film and the substrate or topcoat film and processibility of the paint are elevated. Thus, undercoating paints that have been classified into two classes may be unified into one paint.

Exemplary embodiments of the invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the invention as set forth in the following claims.

1. A urethane-modified polyester resin composition produced by an addition reaction of a polyester resin having a hydroxyl value of about 10 to 50 mgKOH/g and a weight average molecular weight of about 5,000 to 20,000 and isocyanate.

2. The composition of claim 1, wherein the isocyanate is reacted with the polyester resin in a proportion of about 20 to 80% with respect to an equivalent weight of the polyester resin.

3. The composition of claim 1, wherein a glycol component of the polyester resin is at least one selected from the group consisting of ethylene glycol, propylene glycol, 1,4-butylene glycol, 1,6-hexanediol, neopentyl glycol, methyl propanediol, cyclohexane dimethanol, hydrogenated bisphenol A, ethylene oxide added bisphenol A, propylene oxide added bisphenol A, ethylene oxide added bisphenol F, propylene oxide added bisphenol F, ethylene oxide added bisphenol S and propylene oxide added bisphenol S.

4. The composition of claim 3, wherein the glycol component of the polyester resin comprises about 20 to 100% of a first glycol and about 0 to 80% of a second glycol based on a total equivalent weight of the glycol, and wherein the first glycol is at least one selected from the group consisting of ethylene glycol, neopentyl glycol and methyl propanediol, and the second glycol is at least one selected from the group consisting of propylene glycol, 1,4-butylene glycol, 1,6-hexanediol, cyclohexane dimethanol and hydrogenated bisphenol A.

5. The composition of claim 1, wherein an acid component of the polyester resin is at least one selected from the group consisting of phthalic anhydrides, tetrahydrophthalic anhydrides, isophthalic acid, terephthalic acid, adipic acid, azelaic acid, sebacic acid, cyclohexane diacid and trimellitic anhydrides.

6. The composition of claim 5, wherein the acid component of the polyester resin comprises about 50 to 100% of an aromatic acid and about 0 to 50% of an aliphatic acid based on a total equivalent weight of the acid, and wherein the aromatic acid is at least one selected from the group consisting of phthalic anhydrides, tetrahydrophthalic anhydrides, isophthalic acid and terephthalic acid, and the aliphatic acid is at least one selected from the group consisting of adipic acid, azelaic acid, sebacic acid and cyclohexane diacid.

7. The composition of claim 1, wherein the isocyanate is at least one selected form the group consisting of 2,4-toluene diisocyanate, 2,6-toluene diisocyanate, 4,4′-diphenyl methane diisocyanate, 2,4′-diphenyl methane diisocyanate, tetramethylxylene diisocyanate, hexamethylene diisocyanate and isophorone diisocyanate.
